(19) United States
(12) Patent Application Publication
(10) Pub. No.: US 2010/0305806 A1
(43) Pub. Date: Dec. 2, 2010

(54) Portable Multi-Modal Emergency Situation Anomaly Detection and Response System

(76) Inventor: Chadwick Todd Hawley, Woodbridge, VA (US)

Correspondence Address: Chadwick Hawley, 13204 Otto Rd, Woodbridge, VA, 22193, US

(21) Appl. No.: 12/477,079

(22) Filed: Jun. 2, 2009

(51) Int. Cl. G06F 19/00

(52) U.S. Cl. 701/33

(57) ABSTRACT

A portable multi-modal physics and environmental based signature information collection, analysis, and alerting apparatus, device, and method capable of operating independently of vehicle diagnostic or alerting systems. Device uses algorithms and models to calculate, determine, and detect signature anomalies from accelerometer and other imbedded sensors for anomaly response to individual situations within the Automotive Global Information Grid. Wireless infrastructure provisioning of uniquely identified publisher and subscriber Automotive Network Centric Enterprise Services host subscriber and device holder as a persistent publisher presenting signature information on operational and environmental status and conditions. Onboard signature collection and anomaly detection devices support ISO MME, manufacture defined data formats, standard crash analysis algorithms based on ISO, SAE, FMVSS, CMVSS, EuoNCAP, and others. Communications infrastructure is multi-modal providing auto alert capabilities. Machine to machine interface employs W3C standard telematics, and event mark-up language, and the wireless communications utilizing cell phone, satellite, and other communications platforms.

### FIELD OF THE INVENTION

This invention specifically focuses on vehicle and personal service monitoring and alerting systems by providing capabilities which overcome systems limitations of those warning systems which are hard-wired to proprietary onboard diagnostic and reporting systems by providing a highly portable and broad range of normal and emergency detection situation detection thru mathematic and rules based anomaly detection, modeling, and reporting of multiple mode signatures.

### BACKGROUND OF THE INVENTION

This invention comprises a portable device, communications infrastructure, and data to support multi-modal detection of emergency situations, geographic location, communication and confirmation of said situations to a Global Information Grid Network Centric Enterprise Service center of automated and human agents and subscribing down information from the Network Centric Enterprise Service Center emergency call center which in turn communicates the location and emergency situation to appropriate emergency personnel. The device is designed to be extremely portable and configurable to move from vehicle to personal use as the user requires. The legacy of this device is drawn from autonomous unmanned air and ground vehicles which utilize many sensor inputs to characterize, assess, and respond to the vehicles environment. Adaptation of these micro-sensors and sophisticated algorithmic processing of the incoming sensory data allow for high confidence detection of composite signatures associated with personal emergency situations. The legacy of the Global Information Grid and its associated Network Centric Enterprise Services Architecture is drawn from the open systems Service Orientated Architecture (SOA) methodology which expounds best practices for the next generation of internet operations, communications, collaboration, security, interoperability, and services.

r.

### SUMMARY OF THE INVENTION

These redundant signature detection mechanisms provide the user with enhanced situational monitoring and detection of emergencies to include transmission of geographic locations and or projected location. These emergency situations are transmitted to a Global Information Grid Network Centric Enterprise Service Center of automated and human agents and subscribing down information from the Network Centric Enterprise Service Center which in turn provides necessary location information emergency response personnel.

### BRIEF DESCRIPTION OF THE DRAWING

FIG. 1 is a diagram rendering of the embodiment of the Portable Multi-Modal Emergency Situation Anomaly Detection and Response System offered in its stand-alone configuration;

FIG. 2 is a diagram rendering of the embodiment of the functional elements of the Portable Multi-Modal Emergency Situation Anomaly Detection and Response System offered in its stand-alone configuration of FIG. 1;

FIG. 3 is a notional diagram rendering of the embodiment of the Portable Multi-Modal Emergency Situation Anomaly Detection and Response Systems Global Information Grids Network Centric Enterprise Services common Operational Picture as offered in its operational component configuration witch is designed to support the invention of FIG. 1;

FIG. 4 is a notional diagram rendering of the embodiment of the Portable Multi-Modal Emergency Situation Anomaly Detection and Response Systems Sensor Fusion of Composite Signatures which are collected, analyzed, modeled, and configured for alert both locally to the individual subscriber device and onto the Global Information Grids Network Centric Enterprise Services common Operational Picture as offered in its operational detectable component and conditions configuration witch is the embodiment of the inventions methodology which is used to monitor and access the conditions of the subscriber vehicle and is designed to support the invention of FIG. 1

FIG. 5 is a notional diagram rendering of the flow diagram of the Portable Multi-Modal Emergency Situation Anomaly Detection and Response System which shows the means and methods of event analysis, anomaly detection, and automatic notification within the Global Information Grids Network Centric Enterprise Services common Operational Picture as offered in its operational component configuration witch is designed to support the invention of FIG. 1;

FIG. 6 is the detailed diagram rendering itemized summary of the operational information collection, data fusion and analysis, anomaly detection and modeling, alert display, and event response flow diagram of the Portable Multi-Modal Emergency Situation Anomaly Detection and Response System which shows the means and methods of event analysis, anomaly detection, and automatic notification within the Global Information Grids Network Centric Enterprise Services common Operational Picture as offered in its operational component configuration witch is designed to support the invention of FIG. 1;

FIG. 7 is the detailed diagram rendering an itemized summary of the operational subscriber and operational publishers identity management information collections world model, data fusion, component agent analysis, anomaly detection, software knowledge agent monitoring and modeling, alert display, and event response flow diagram of the Portable Multi-Modal Emergency Situation Anomaly Detection and Response System which shows the means and methods of event analysis, anomaly detection, and automatic notification within the Global Information Grids Network Centric Enterprise Services common Operational Picture as offered in its operational component configuration witch is designed to support the invention of FIG. 1;

### DETAILED DESCRIPTION OF THE INVENTION

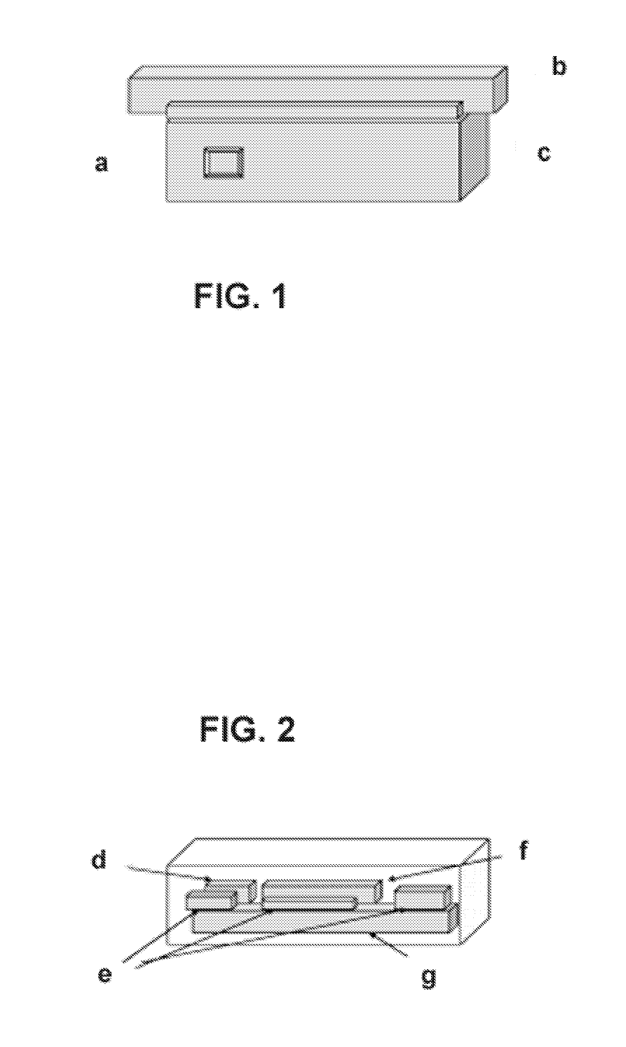

FIGS. 1 and 2 provide the detailed diagram rendering of the programmable digital microprocessor device of the operational subscriber which is designed to be mounted onto any one of the nations 200 million automotive vehicles to serve as an alert, communications, and collaboration platform. This notification system is dependent upon the operational vehicle for battery regeneration power only and operational users, represented as subscribers become members of a network of devices where their individual identity is managed throughout a world modeled information collections network within a system that keeps them in direct contact with a Network Centric Enterprise Services organization.

This same device is structured to also serve as a publisher of actual information and data related to the position, attitude, speed, and environmental elements to which the vehicle is currently exposed. This information is published into the Global Information Grid through a unique metadata standard mark-up language and a world model is generated. Publishers such as advertisers, restaurants, gas stations, and other service or product providers are also able to participate as publishers to the Global Information Grid. Data fusion, component agent analysis, anomaly detection, software knowledge agent monitoring and modeling, alert display, and event response flows both too and from the Portable Multi-Modal Emergency Situation Anomaly Detection and Response System producing both the means and methods of event analysis, anomaly detection, and automatic notification within the Global Information Grids Network Centric Enterprise Services common Operational Picture. The alert notification and the interoperable communications are all a part of this same device. The user interface will vary however the mobile processor and the Network Centric Enterprise Service server configuration will host its own database infrastructure which is designed to use the same voice and data network infrastructure.

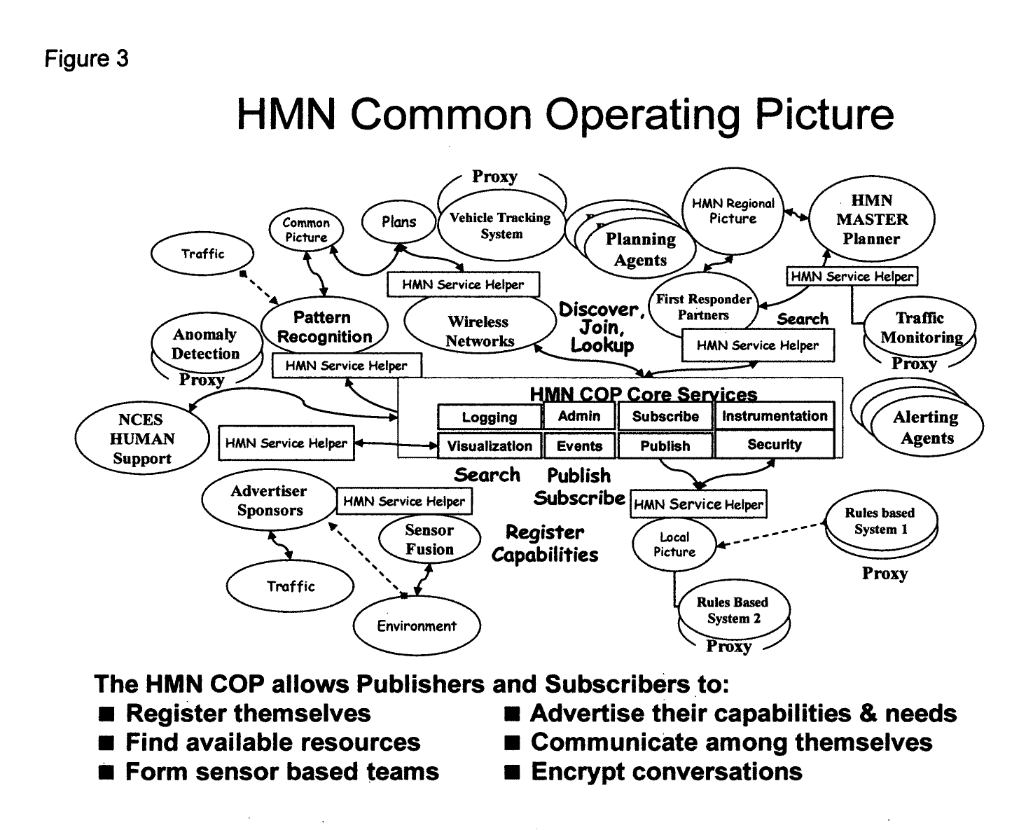

FIG. 3 is a notional diagram rendering of the embodiment of the Portable Multi-Modal Emergency Situation Anomaly Detection and Response Systems Global Information Grids Network Centric Enterprise Services common Operational Picture as offered in its operational component configuration. This Grid environment serves as the primary communications interoperable interface for machine to machine and man to machine wireless communications. It is designed to embody the compatible with multiple existing wireless platforms extending from existing legacy cell phone communications infrastructure to 802.11n for the specific intent to drastically increase on-board wireless data rates from 54 megabits per second as delivered by the existing 802.11g standard to 248 megabits per second within the onboard processor network. This portion of the apparatus and this claim serves to identify this construct as the wireless communication infrastructure for current and future vehicle alert notification systems, such as breaks, tires, engine diagnostics, etc. This claim also takes into account that the apparatus and the infrastructure will use 802.11n wireless equipment to marry the onboard wireless networking of devices with network, identity, security, and system/application support. This approach is specifically designed to apply the 802.11n capability with cellular and WiMax to form a seamless mobile WAN Global Information Grid architecture. This portion of the claim is intended to identify our methodology for secure connectivity from any device, any network, and any location. All communications for on-board systems and throughout the Global Information Grid are bi-directional with the environmental and other future proposed sensors having the capability to operate as both wired and wireless devices, depending on the configuration. The system will connect to publicly available networks for access to public databases and content through the internet and other open sourced venue. The system will also maintain a ability to operate as a closed system for internal corporate and law enforcement use. The law enforcement utilization shall employ the wireless, communications, and database in conjunction with the 700 MHZ frequency spectrum as a primary claim under this submission.

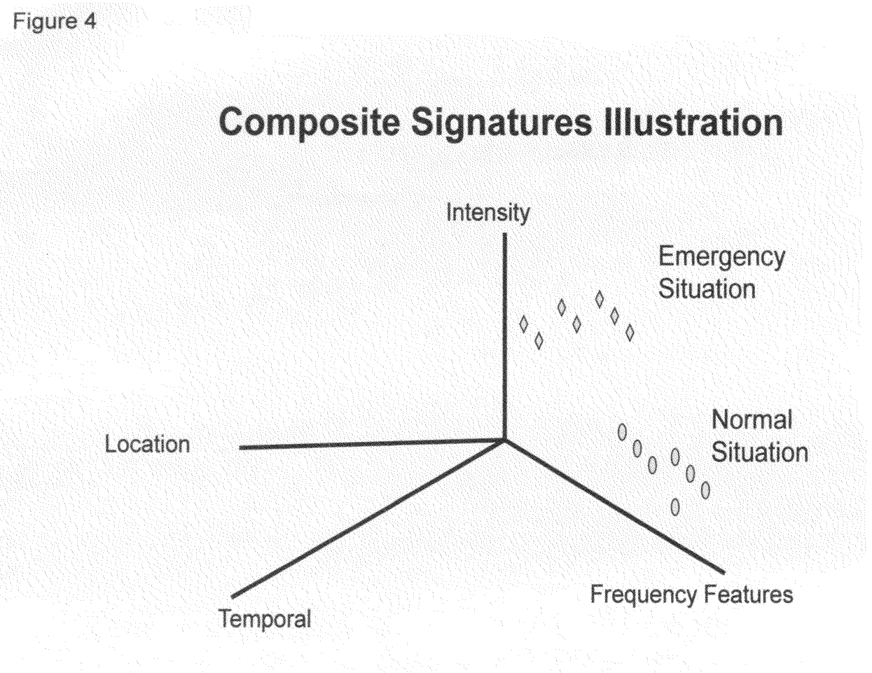

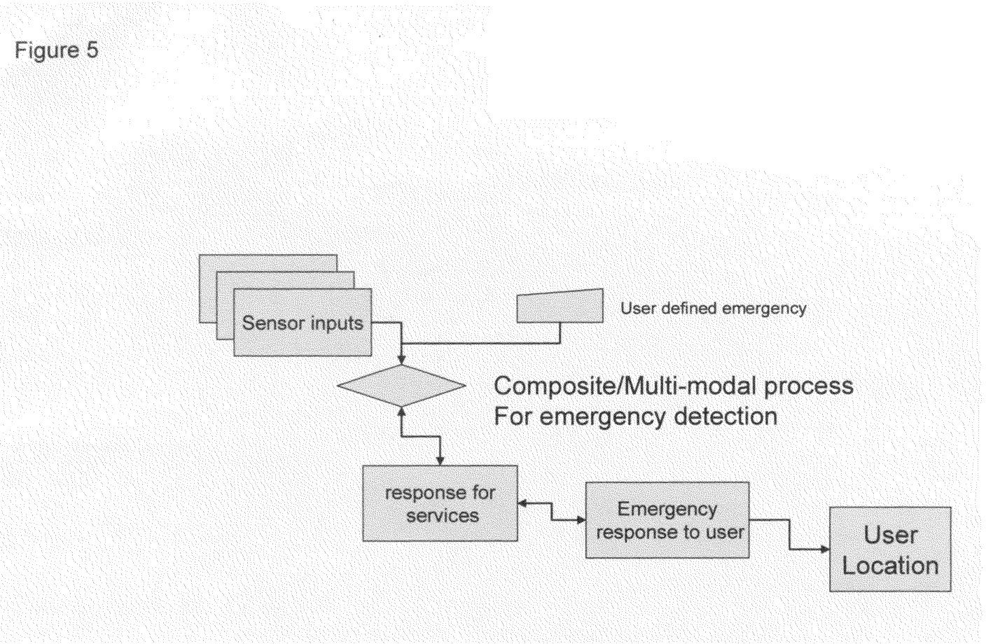

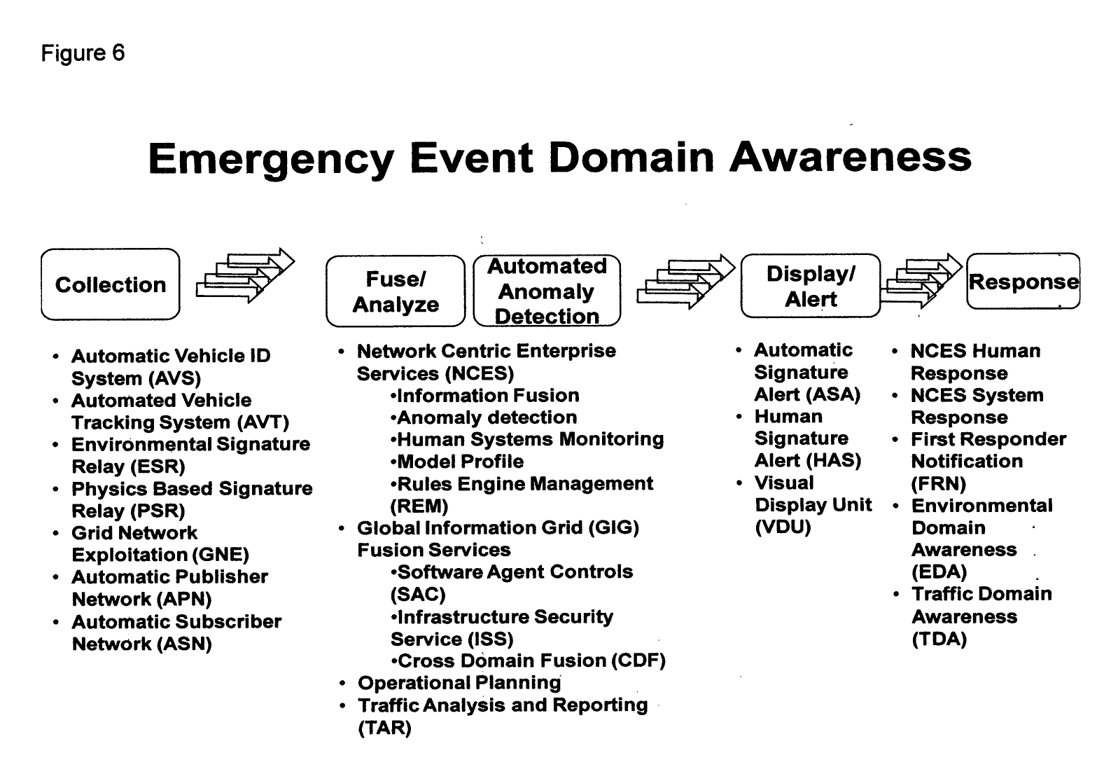

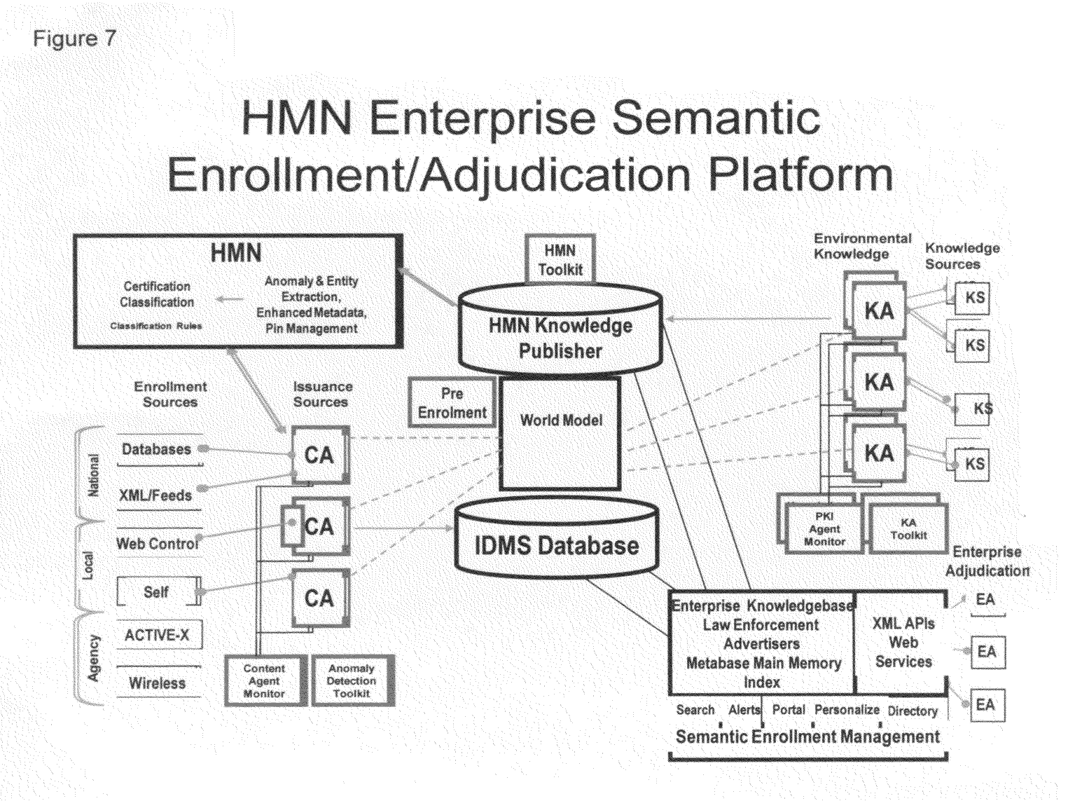

FIGS. 4, 5, 6, and 7 represent the notional and operational diagram rendering of the embodiment of the Portable Multi-Modal Emergency Situation Anomaly Detection and Response Systems Sensor Fusion of Composite Signatures which include the data models which are collected, analyzed, modeled, and configured for alert both locally to the individual subscriber device and onto the Global Information Grids Network Centric Enterprise Services Common Operational Picture as offered in its operational detectable component and conditions configuration witch is the embodiment of the inventions methodology which is used to monitor and access the conditions of the subscriber vehicle and is designed to support the invention. The Anomaly Detection and Response System is designed to identify and report non-obvious relationships and events that are precursors to a significant event of interest which has been modeled or defined in rules. The specific physics or environmental based signature will allow appropriate alert or in the case of inclement whether, counter-measures to be taken to alert, prevent or moderate the previously defined behavior. The device and its secure Network Centric Enterprise Services Global Information Grid web services subscribers and publishers includes an enterprise application which reduce analytic and information dissemination time by off-loading anomaly detection and analysis tasks from humans while providing increased situational awareness and visibility of the common operating picture within the complete Structured Vehicle Collaboration space.

The first activity of the anomaly detection and reporting system analysis is to perform the following:

a. Identify individual, vehicle make and model, location, and physics and environmental based events to be modeled, ex. Force of Gravity necessary to deploy a Side Air Bag within a 2007 Ford Exploiter
b. Identify precursors of individual, vehicle make and model, places, and physics and environmental based events of interest
c. Identify data sources related to a and b, including access information, formatting information, and related properties necessary for utilization and presentation into a COP
d. Identify algorithms that will utilize the identified data to generate the events of interest (anomaly detection algorithms)
e. Identify modes of surveillance to provide the most effective situational awareness
f. Identify Anomaly Detection and Response System event management service requires the system to post alerts, visualize, review, and manipulate the data and verbal communications policy within the Network Centric Enterprise Service environment.

The Second requirement of the Anomaly Detection and Responce System requires the confirmation of potential comparative knowledge based data that will represent information related to those events of interest for alert models. Properties of those databases/data sources that are required for the anomaly models are processed for applicability, format, quality, size, and any other information that might impact the acquisition and use of the data in that particular database. The types of data of interest for the models include vehicle standards and crash data, geospatial data, speed, direction, and environmental data from weather stations, vehicles and other sensors.

Third, all Data will must be made available to the Anomaly Detection and Response system through a Service Orented Architecture enabled Extract Transfer Load (ETL) database application for normalization and cleansing prior to Anomaly analysis. The initial subsystems of the ETL architecture address the issues of understanding your source data, extracting the data and transferring it to the data warehouse environment where the ETL data and metadata systems can operate independent of the onboard anomaly detection operational systems. This will allow the adaptation of the SOA based systems necessary for data cleansing to cohabitate at the data layer thereby allowing anomaly detection and response to operate in three Cross Domain dimensions. While the remaining subsystems focus on the transforming, loading and system management within the ETL environment, the initial subsystems interface to the source systems to access the required data. The extract-related Anomaly Detection and response System ETL subsystems include:

Automotive and Event Data Profiling—investigates a data source to determine its fit for inclusion as a source and the associated cleaning and conforming requirements.
Automotive and Event Change Data Capture—Isolates the changes that occurred in the source system to reduce the ETL processing burden while positioning the optimum data to the algorithms for analysis.
Automotive and Event Extract System—Extracts and moves source data into the data warehouse environment for further processing.

Automotive and Event Cleansing and Conforming Data—This where the Anomaly Detection and Response ETL system adds value to the data including but not limited to the allocation of geospatial and temporal metadata reference. The other activities, extracting and delivering data, are obviously important, but they simply move and load the data. The cleaning and conforming subsystems change data and enhance its value to the anomaly detection and event notification analytical process. In addition, these subsystems create metadata used to diagnose source-system problems. Such diagnoses is used to prevent false positives and will lead business process engineering initiatives to address the root causes of dirty or non-conforming data and to insure data quality over time.

The system is designed to incorporate geospatial, commercial, and other content into the ETL data cleaning process. It is also expected to repair dirty data. The data warehouse is designed to provide an accurate picture of the data as it was captured by the Network Centric Enterprise Service production systems. It is essential to strike the proper balance between these conflicting goals. The ETL system is capable of correcting, rejecting or loading data as is, and then highlighting, with easy-to-use structures, modifications, standardizations, rules and assumptions of the underlying cleaning apparatus so as to allow the system to be self-documenting.

The five major ETL subsystems in the cleaning and conforming step include:

Automotive and Event Data Cleansing System—Implements data quality processes to catch quality violations.
Automotive and Event Error Tracking—Captures all error events that are vital inputs to data quality improvement.
Automotive and Event Audit Dimension Creation—Attaches metadata to each fact table as a dimension. This metadata is available to applications for visibility into data quality.
Automotive and Event De-confliction/duplication—Eliminates redundant members of core dimensions. This will require integration across multiple sources and application of survivorship rules to identify the most appropriate version of duplicate data.
Automotive and Event Data Conformance—Enforces common dimension attributes across conformed Master Ontological and Taxonomical Dimensions (MOTD) and common metrics across related fact tables.

Given the proper availability and conformance of disparate data, the third phase of the Anomaly Detection and Response System analysis and model Anomaly investigation is to identify the types of algorithms for anomaly detection that will be applied to the types of data available from the Portable Multi-Modal Emergency Situation Anomaly Detection and Response System onboard processors and the identified data sources. As other data sources are identified, these algorithms would be modified to include the additional information in the anomaly determination process. The selection of algorithms is important as illustrated in the following: The models for temporal data within the Portable Multi-Modal Emergency Situation Anomaly Detection and Response System are identified as autoregressive integrated moving average. One of the primary benefits of autoregressive integrated moving average models is their ability to correct for local trends in the data. Example, in the case of environmental considerations, the weather that has occurred on the previous day is incorporated into the forecast of what will happen today. Additionally environmental models based on current conditions are considered in conjunction with weighted guidelines. In event highway driving anomaly analysis, this works well in modeling natural and human behavior. Autoregressive integrated moving average models are fitted by least squares regression to find the values of the parameters which minimize the error term and will use Yule-Walker type equations to provide a fit and cross reference the solution with the Least Squares Fit method as a solution check and balance. The embodiment of the methodology is not solely dependent to a specific algorithmic cocktail.

The structural example presented below and its corresponding reference diagrams as exerted from 49 CFR present the governments own mandatory algorithm as utilized in Federal Motor Vehicle Safety Standard (FMVSS) certification with reference to Center of Gravity and is represented as follows:

49 CFR Ch. V (10-1-04 Edition) at S6.2 Head injury criteria. (a) (1) For any two points in time, t1 and t2, during the event which are separated by not more than a 36 millisecond time interval and where t1 is less than t2, the head injury criterion (HIC36) shall be determined using the resultant head acceleration at the center of gravity of the dummy head, ar, expressed as a multiple of g (the acceleration of gravity) and shall be calculated . . . (2) The maximum calculated HIC36
value shall not exceed 1,000

These time series models as documented in existing crash test documentation for every vehicle make and model will be used for predicting current behavior and for forecasting the future behavior of variables. These vehicle behavior models accounts for the fact that data points taken over time will have a well defined internal structure related to items such as autocorrelation, trend or seasonal variation, which accounted for continuous model baseline update and modification. As a result standard regression techniques will be applied to time series data and methodology which has been developed to decompose the trend, seasonal and cyclical component of the series. Modeling the dynamic path of a variable serves to improve forecasts by having the predictable component of the series projected into the future.

The information below describing the differentiation of event consequence based on size of the individual is extracted from the same FMVSS CFR documentation. When this data is used in conjunction with the embodiment of this patent, many unique functional capabilities become available to the safety and security of vehicle operators and passengers. For the first time in the history of vehicle operations, under the embodiment of this patent, when the anomaly detection algorithms are applied to a specific vehicle, not only can the automated and human monitors at the Network Centric Enterprise Service command center alert first responders to the location of a crash scene, but they can also project to medical staff the potential for injury which may not be initially apparent given the obvious differentiation in effect of a 30 MPH crash on a 6 year old child as compared to a 95 percentile male.

This same methodology will also extend the embodiment of the patent use for predicting or forecasting weather, traffic, or vehicle security “left of event” notification. The dynamic nature of automated system agents operated within the Global Information Grid are modeled to alleviate or minimize vehicle events such as chain reaction crashes based on both actual event notifications from existing subscriber notification as cross referenced with environmental sensor signature analysis. In this case, the rates would be adjusted by the autoregressive integrated moving average model, thus providing an alarm from a non-obvious relationship being monitored or triggered every minute of every day throughout year. This provides a mathematical basis for cross correlating environment and physics based sensor alerts with actual event notification. This type of information may be used to assist in the performance of analytical task such as adjusting the deployment schedule of law enforcement, and other highway service provider assets which may be available to the Help Me Now Common Operational Picture environment which, in and of itself is modeled for specific activity.

The COP is extensible based on its SOA Architecture for future work with the algorithms identified by other participating parties. Data input includes parameterized and aggregated data either in a single time series, an array time series, a text time series indexed by time, or a time index driven by supplementary field data comprising a categorical response from the sensor, geospatial, environmental and physics based network input. Each algorithm includes a number of parameters that may be set for regional differentiation. The individual analytic function is dependent on the structure of the input data and on the algorithm itself.

The information output and eventual alert is modeled and formalized as a set of scores, presented into a heterogeneous scores database. There are single score alerts and vectors of scores, for each input data point. Scores are compared to model thresholds. The scores in a group are related as (i) scores from the same time series across successive time points, and (ii) scores across different time series (from the same or different data sectors) where subject matter expertise indicates that the time series are related.

Anomalies are categorized as an event (keyed by geography, data feed, conditions, or time), where the event score exceeds a preset threshold. In the statistical anomaly detection setting, an event contains a score, the algorithm, and the algorithm parameters. If score>=threshold (geography, data feed, environmental conditions, time, algorithm, algorithm parameters), then the event is an anomaly. The success of the Asymmetric Automotive Alert (AAA) system is based on the random formalization of the intuitive idea of the subscriber network and publisher network organizations taking independent successive steps through individual social networks, each individual moving in a random direction. In nature the path traced by a molecule as it travels in a liquid or a gas is random. The travel of individual subscribers is much more predictable based on the general repeatable path to logical destitutions. The mathematical representation of the “drunkard's random walk” is a notational representation within the Global information Grid to which multiple elements of the Network Centric Enterprise Service may be triggered.

The notation AR(p) refers to the autoregressive model of order p. The AR(p) model is written

$${X}_{t} = c + {\sum }_{i = 1}^{p} {ϕ}_{i} {X}_{t - i} + {ɛ}_{t} ,$$

where φ₁ . . . , φ₂ are the parameters of the model, c is a constant and εₜ an error term.

In the case of the Anomaly Detection and Response Systems autoregressive model is essentially an infinite impulse response with some additional interpretation placed on it which can be adjusted to conform to the individual problem. This will allow the system to have simple wizards to which the anomaly detection analysis becomes available and useable to the lowest level of experience or training within the operating center. The use of the system, its content, and/or its analytics by subscribers, publishers, call center response personnel and others are modeled specific to their operational needs without exposing core means, methods, or algorithms is also a benefit that drives the ease of use.

The embodiment of the Asymmetric Automotive Alert system is programmable and compatible with geospatial, internet, telephone, pager and other communications devices. This capability allows individuals (parents, employers) to employ their own models through features available through their web based system access. Given the SOA based open system architecture, this system allows for access to existing telephone and other onboard or mobile GPS tracking systems. Given the web based access of the system, corporations may couple the AAA system use to their own internal production and shipping systems for alert notification or those of established logistical shippers such as UPS or Federal Express. Service Providers such as Cable Installers, Home Product Repair Technicians, Plumbers, Exterminators, can couple the automated or human alert notification system to extend an automatic Asymmetric Customer Alerts, thereby providing extended service while maximizing worker productivity. Given the web based nature of the system it is compatible with existing mobile reporting systems which may not have a dynamic communication reporting capability.

The embodiment and automated nature of the system and the wireless nature of the infrastructure also makes the detailed embodiment of the system intentionally and unequally compatible with existing satellite communications devices and network infrastructure such as XM, Sirius, Tritium, and others. Multiple applications from alert notification to interactive command and control communications will serve to extend the functional capabilities of these networks. The embodiment of the interactive nature of the device and the system also allows for payment through well established on-line functions with invoicing capabilities existing within the Network Centric Enterprise Services infrastructure.

The embodiment of the device and the system provides an ability to reduce the device capabilities to the circuit board and chip set level also makes the mobility of the devise and the extension of the Global Information Grid extensible to existing telephone, radio, pager, laptop, alert and monitoring devices as imbedded capabilities for subscriber, publisher, or interactive use. The imbedded use of the chip and the wireless communications infrastructure could, for example make vehicle theft obsolete without the owner ever having to become involved with the monthly service fee for Network Centric Enterprise Services by the activation of a remote “Asymmetric Automotive Kill Switch”.

It is understood that this invention is a categorical departure from hard-wired event discovery and reporting systems, however many of the elements produced in the description of this art may be transferable to those proprietary systems. The information, methodology, algorithms, means, and methods expressed in this invention will be embodied in other submittals as both an extension and clarification of this submittal while maintaining the spirit, intent, and character herewith. Therefore it should be understood that the information and descriptions disclosed here are for descriptive purposes and shall not be construed to limit in any way the confines of the invention as submitted.

I claimed:

1. A highly portable device to detect multiple physics and environmental based signatures associated with emergency or non emergency situations which includes multiple sensors to automatically detect anomalies and emergency situations; and to automatically communicate the location of the subscriber to the call center; and to self activate a communication system to allow the call center to communicate with the user, assess the situation with connectivity between the device, the call center, and the appropriate emergency response system or service to an individual or set of individuals comprising:
a) a portable multi-mode signature sensor and processing suite device capable of receiving and analyzing abnormalities onboard the vehicle,
b) a portable multi-mode signature sensor and processing suite device capable of publishing sensor information onboard the vehicle to a global information grid,
c) a portable multi-mode signature sensor and processing suite device capable of receiving and analyzing abnormalities external to the vehicle,
d) a portable multi-mode signature sensor and processing suite device capable of publishing sensor information and external environmental information to a global information grid,
e) a global positioning system capable of identification of position and tracking of position,
f) a two way communication system to a Network Centric Enterprise Service Center
g) an emergency alert two way communications system

2. A Portable Multi-Modal Emergency Situation Anomaly Detection and Response System according to claim 1, comprising;
a) methodology and procedures to support a portable multi-mode signature sensor and processing suite device capable of receiving and analyzing abnormalities onboard the vehicle,
b) methodology and procedures to support a portable multi-mode signature sensor and processing suite device capable of publishing sensor information onboard the vehicle to a global information grid,
c) methodology and procedures to support a portable multi-mode signature sensor and processing suite device capable of receiving and analyzing abnormalities external to the vehicle,
d) methodology and procedures to support a portable multi-mode signature sensor and processing suite device capable of publishing sensor information and external environmental information to a global information grid,
e) methodology and procedures to support a global positioning system capable of identification of position and tracking of position,
f) methodology and procedures to support a two way communication system to a Network Centric Enterprise Service Center
g) methodology and procedures to support an emergency alert two way communications system

3. A highly portable set of algorithms to detect and analyze multiple signatures associated with emergency or non emergency situations which includes multiple sensors to automatically detect anomalies and emergency situations and automatically communicate the location of the subscriber to the call center and to activate a communication system to allow the call center to communicate with the user and assess the situation with connectivity between the device, the call center and the appropriate response system or emergency service to an individual or set of individuals comprising:
a) algorithms and models to support a portable multi-mode signature sensor and processing suite device capable of receiving and analyzing abnormalities onboard the vehicle,
b) algorithms and models a portable multi-mode signature sensor and processing suite device capable of publishing sensor information onboard the vehicle to a global information grid,
c) algorithms and models a portable multi-mode signature sensor and processing suite device capable of receiving and analyzing abnormalities external to the vehicle,
d) algorithms and models a portable multi-mode signature sensor and processing suite device capable of publishing sensor information and external environmental information to a global information grid,
e) algorithms and models a global positioning system capable of identification of position and tracking of position,
f) algorithms and models a two way communication system to a Network Centric Enterprise Service Center
g) algorithms and models an emergency alert two way communications system

4. A highly portable set of event models to detect multiple signatures associated with emergency or non emergency situations which includes multiple sensors to automatically detect anomalies and emergency situations and automatically communicate the location of the subscriber to the call center and to activate a communication system to allow the call center to communicate with the user and assess the situation with connectivity between the device, the call center and the appropriate response system or emergency service to an individual or set of individuals comprising:
a) anomaly and event models to support a portable multi-mode signature sensor and processing suite device capable of receiving and analyzing abnormalities onboard the vehicle,
b) anomaly and event models to support a portable multi-mode signature sensor and processing suite device capable of publishing sensor information onboard the vehicle to a global information grid,
c) anomaly and event models to support a portable multi-mode signature sensor and processing suite device capable of receiving and analyzing abnormalities external to the vehicle,
d) anomaly and event models to support a portable multi-mode signature sensor and processing suite device capable of publishing sensor information and external environmental information to a global information grid,
e) anomaly and event models to support a global positioning system capable of identification of position and tracking of position,
f) anomaly and event models to support a two way communication system to a Network Centric Enterprise Service Center
g) anomaly and event models to support an emergency alert two way communications system

5. The device which utilizes sophisticated composite signatures to reduce false positive alerts and alarms. These composite signatures comprise system learning of physics, environmental and behavioral based signatures through a sequence of feed back and feed forward analysis based on rules based templates comprising of operational steps which:
a) receive and analyze temporal parameters recorded by the onboard system
b) receive and analyze intensity parameters recorded by the onboard system
c) receive and analyze frequency parameters recorded by the onboard system
d) receive and analyze feature, temperature, and pressure parameters recorded by the onboard system and compared to known and trusted data source information
e) receive and analyze geospatial parameters recorded by the onboard system and compared to known and trusted data source information
f) combined temporal, intensity, frequency, direction, feature, temperature, pressure, geospatial, space and other sensor data into analytic models to indicate that a personal emergency situation is occurring as apposed to a false positive.

6. The methodology which utilizes sophisticated composite signatures to reduce false positive alerts and alarms. These composite signatures comprise system learning of physics, environmental and behavioral based signatures through a sequence of feed back and feed forward analysis based on rules based templates comprising of operational steps and personnel which:
a) receive and analyze temporal parameters recorded by the onboard system
b) receive and analyze intensity parameters recorded by the onboard system
c) receive and analyze frequency parameters recorded by the onboard system
d) receive and analyze feature, temperature, and pressure parameters recorded by the onboard system and compared to known and trusted data source information
e) receive and analyze geospatial parameters recorded by the onboard system and compared to known and trusted data source information
f) combined temporal, intensity, frequency, direction, feature, temperature, pressure, geospatial, space and other sensor data into analytic models to indicate that a personal emergency situation is occurring as apposed to a false positive.

7. The algorithms which utilizes sophisticated composite signatures to reduce false positive alerts and alarms. These composite signatures comprise system learning of physics, environmental and behavioral based signatures through a sequence of feed back and feed forward analysis based on rules based templates comprising of operational steps which:
a) receive and analyze temporal parameters recorded by the onboard system
b) receive and analyze intensity parameters recorded by the onboard system
c) receive and analyze frequency parameters recorded by the onboard system
d) receive and analyze feature, temperature, and pressure parameters recorded by the onboard system and compared to known and trusted data source information
e) receive and analyze geospatial parameters recorded by the onboard system and compared to known and trusted data source information
f) combined temporal, intensity, frequency, direction, feature, temperature, pressure, geospatial, space and other sensor data into analytic models to indicate that a personal emergency situation is occurring as apposed to a false positive.

8. The processing models which utilizes sophisticated composite signatures to reduce false positive alerts and alarms. These composite signatures comprise system learning of physics, environmental and behavioral based signatures through a sequence of feed back and feed forward analysis based on rules based templates comprising of operational steps which:
a) receive and analyze temporal parameters recorded by the onboard system
b) receive and analyze intensity parameters recorded by the onboard system
c) receive and analyze frequency parameters recorded by the onboard system
d) receive and analyze feature, temperature, and pressure parameters recorded by the onboard system and compared to known and trusted data source information
e) receive and analyze geospatial parameters recorded by the onboard system and compared to known and trusted data source information
f) combined temporal, intensity, frequency, direction, feature, temperature, pressure, geospatial, space and other sensor data into analytic models to indicate that a personal emergency situation is occurring as apposed to a false positive.

9. An anomaly detection and vehicle alerting system which is comprised of:
a) the sensors, devices, analytic and anomaly detection models of claims 1-8 which alerts into the Automotive Global Information Grid Network Centric Enterprise Service Center of automated and human agents,
b) a geospatial locator that automatically reports the vehicle location and route,
c) a communication devise which is capable of automatically reporting and publishing alerts into the Global Information Grid Network Centric Enterprise Service center of automated and human agents and subscribing down information from the Network Centric Enterprise Service Center.
d) a system which detects, reports, and analyzes environmental conditions.
